(19) United States
(12) Patent Application Publication
(10) Pub. No.: US 2005/0180766 A1
(43) Pub. Date: Aug. 18, 2005

(54) Developing method of liquid type electrophotographic image forming device

(76) Inventors: Joong-gwang Shin, Seongnam-si (KR); Kyu-cheol Shin, Seoul (KR); Sung-keun Park, Chilgok-gun (KR)

Correspondence Address: STANZIONE & KIM, LLP, 1740 N STREET, N.W., FIRST FLOOR, WASHINGTON, DC, 20036, US

(21) Appl. No.: 11/022,783

(22) Filed: Dec. 28, 2004

(30) Foreign Application Priority Data
Dec. 29, 2003 (KR) 2003-99036

(51) Int. Cl. G03G 15/10

(52) U.S. Cl. 399/55; 399/240

(57) ABSTRACT

A developing method of a liquid type electrophotographic image forming device includes forming an image area corresponding to an electrostatic latent image by scanning light onto a surface of a photosensitive drum that is charged to a predetermined electric potential, attaching a developer on a surface of a developing roller by applying a first bias voltage to a deposit roller and a second bias voltage to the developing roller, developing the image area on the photosensitive drum using the developer attached to the developing roller, and turning off the second and first bias voltages applied to the developing roller and the deposit roller, respectively, when a non-image area of the photosensitive drum contacts the developing roller.

### CROSS-REFERENCE TO RELATED APPLICATIONS

This application claims the priority of Korean Patent Application No. 2003-99036, filed on Dec. 29, 2003, in the Korean Intellectual Property Office, the disclosure of which is incorporated herein in its entirety by reference.

### BACKGROUND OF THE INVENTION

1. Field of the Invention

The present general inventive concept relates to a developing method of a liquid type electrophotographic image forming device, and more particularly, to a developing method that prevents image quality from degrading during a developing process by preventing a developing liquid carrier transferred from a developing roller to a photosensitive medium from being used in processes other than an imaging process.

2. Description of the Related Art

In general, a liquid type electrophotographic image forming device is a device that scans light onto a photosensitive body to form an electrostatic latent image corresponding to a desired image on the photosensitive body, and develops the image with an ink having a predetermined color to obtain the desired image.

The electrophotographic image forming device can be divided into a dry type and a liquid type according to the kind of toner. The dry type image forming device uses a toner of a powder state. To the contrary, the liquid type image forming device uses a developer of a liquid type, in which a volatile liquid carrier is mixed with a toner. The liquid type image forming device has a higher printing quality than that of the dry type image forming device and can prevent a damage due to a toner dust. The developer is referred to as an ink.

FIG. 1 shows a developing device of a general liquid type electrophotographic image forming device.

Referring to FIG. 1, the developing device includes an ink storage unit 40, in which ink (developer) is stored, an ink container 26 that receives the ink from the ink storage unit 40 through a pump P1, and a developing roller 12 that receives the ink from the ink container 26 and develops an electrostatic latent image formed on a photosensitive body (drum) 10.

A deposit roller 16 that attaches the ink in the ink container 26 onto a surface of the developing roller 12, a metering roller 14 that controls a height of the ink on the developing roller 12 to be in a predetermined range, and a cleaning roller 18 that cleans the ink remaining on the developing roller 12 after a developing process is completed, are disposed around the developing roller 12.

In FIG. 1, reference numeral 19 denotes a charging roller that charges the photosensitive drum 10 to a predetermined electric potential, reference numeral 20 denotes a laser scanning unit (LSU) that scans a laser beam onto the photosensitive drum 10 to form the electrostatic latent image, and reference numeral 22 denotes a cleaning blade that removes the ink remaining on the surface of the photosensitive drum 10. In addition, reference numeral 28 denotes an ink collector that recovers the ink leaking out of the ink container 26 during the developing process. The ink storage unit 40 supplies the ink to the ink container 26 and stores the ink recovered from the ink collector 28 through a pump P2.

The developing roller 12 is a conductive elastomer and is fabricated using polyurethane rubber or nitrile-budadiene rubber (NBR). It is desirable that a resistance of the material is 10⁵-10⁸ ohm, a hardness is 25˜65(Shore A), and a surface roughness is 1˜4 μm. The developing roller 12 having the above resistance and the roughness supplies the developer to the photosensitive body 10 through a developing nip N. A developing bias voltage of 500V-600V is applied to the developing roller 12.

The photosensitive drum 10 is charged by the charging roller 19 to a high voltage (Vopc) about 1000V, and a portion scanned by the laser scanner unit (LSU) 20 is lowered to 100V to form the electrostatic latent image. The photosensitive drum 10 contacts or non-contacts the developing roller 12, and the developing nip N is formed between the photosensitive drum 10 and the developing roller 12.

The deposit roller 16 is submerged in the ink in the ink container 26, and a bias voltage of 800V˜900V is applied from an external power unit to the deposit roller 16 in a state where a predetermined gap is interposed between the deposit roller 16 and the developing roller 12 to attach the developer onto the developing roller 12. The deposit roller 16 is separated from the developing roller 12 about 50˜500 μm, and more desirably, about 200˜300 μm.

The cleaning roller 18 is fabricated of a sponge and cleans the developer remaining on the developing roller 12.

In the developer, toner particles, which are electrically charged, are distributed in a liquid carrier with 3%˜20% concentration. The toner concentration (% solid) on the developing roller 12 that passed through the metering roller 14 is about 18%˜35%.

FIG. 2 is a view illustrating a timing chart applied in the conventional developing method of FIG. 1.

Referring to FIGS. 1 and 2, the photosensitive drum 10 is charged by the charging roller 19 to a predetermined electric potential (Vopc), for example, 1000V. In addition, a surface of the photosensitive drum 10 is exposed by the LSU 20 to lower the voltage of the exposed surface to a predetermined potential, for example, 100V to form the electrostatic latent image.

On the other hand, when the bias voltage Vdep of 900V is applied to the deposit roller 16, and the bias voltage Vdev of 600V is applied to the developing roller 12, the deposit roller 16 attaches the developer on the developing roller 12 to which a lower voltage is applied. In addition, when the metering roller 14 presses the developing roller 12 in a state where a predetermined potential, for example, 900V voltage is applied to the metering roller 14, so that the developer on the developing roller 12 is controlled to be a predetermined thickness.

In addition, the toner on the developing roller 12 is moved from the developing nip facing the electrostatic latent image on the image area of the photosensitive drum 10 to the exposed surface, where the electrostatic latent image is formed, on the photosensitive drum 10 by a potential difference.

However, according to the conventional image forming device, since the bias voltages Vdev and Vdep are applied to the developing roller 12 and the deposit roller 16, respectively, when the photosensitive drum 10 is charged at image areas (IAs) and a non-image area (NIA), to which the laser beam is not scanned, between the image areas (IAs), most of toners contained in the developer at the developing nip N are attached to the developing roller 12, while a carrier of the developer is relatively concentrated on the photosensitive drum 10. Therefore, the carrier is largely consumed on the photosensitive drum 10, and a lot of carrier is used. Also, the excessive carrier on the NIA of the photosensitive drum 10 may cause a problem of dragging the image on the IA.

### SUMMARY OF THE INVENTION

The present general inventive concept provides a developing method of a liquid type electrophotographic image forming device, the method of reducing a carrier consumption on a non-image area to improve an image quality.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a developing method of a liquid type electrophotographic image forming device, the method including forming an image area corresponding to an electrostatic latent image formed by scanning light onto a surface of a photosensitive drum that is charged to a predetermined electric potential, attaching a developer on a surface of a developing roller by applying a first bias voltage to a deposit roller and a second bias voltage to the developing roller, and developing the image area on the photosensitive drum using the developing roller, on which the developer is attached. The method may further include turning off the second and first bias voltages that are applied to the developing roller and the deposit roller when a non-image area of the photosensitive drum contacts the developing roller.

The method may further include removing a toner remaining on the photosensitive drum before the forming of the image area, and the removing of the remaining toner may include applying a predetermined voltage to the photosensitive drum and not applying the second and first bias voltages to the developing roller and the deposit roller.

The method may further include removing the toner remaining on the photosensitive drum after the forming of the image area.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic cross-sectional view illustrating a general liquid type electrophotographic image forming device;

FIG. 2 is a view illustrating a timing chart of voltages applied in the conventional developing method of FIG. 1;

FIG. 3 is a view illustrating a timing chart of voltages applied in a developing method of a liquid type electrophotographic image forming device according to an embodiment of the present general inventive concept; and

FIG. 4 is a block diagram illustrating a control unit adopting a developing method according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

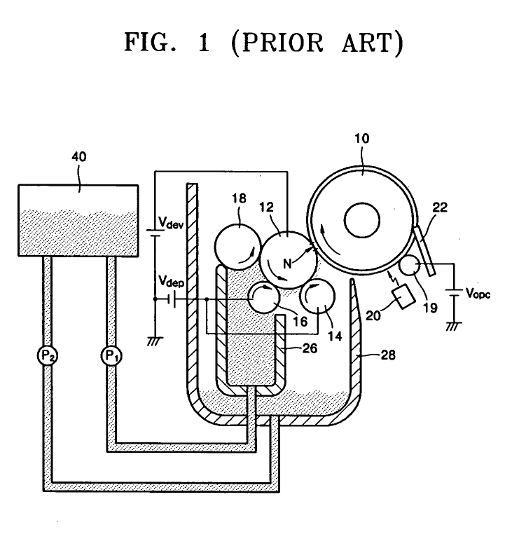

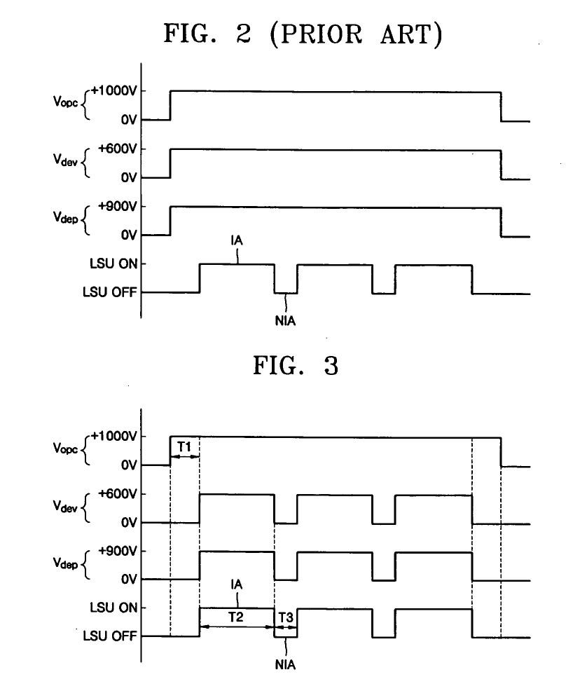

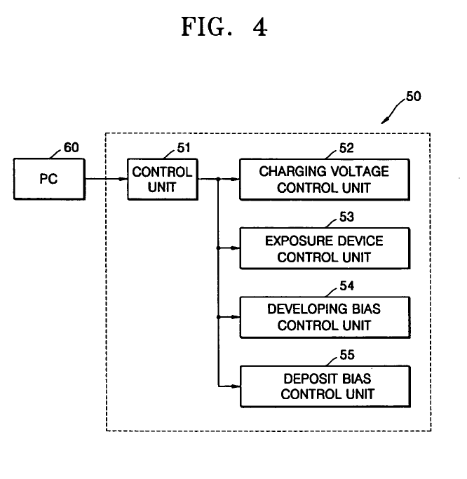

FIG. 3 is a view illustrating a timing chart of voltages applied in a developing method of a liquid type electrophotographic image forming device according to an embodiment of the present general inventive concept, and FIG. 4 is a block diagram illustrating a control unit adopting a developing method according to an embodiment of the present general inventive concept. The developing method of FIG. 3 and the developing unit of FIG. 4 will be described using a image forming device shown in FIG. 1.

Referring to FIGS. 3 and 4, in the developing method, when a printing signal is input into a control unit 51 of a printer 50 from an external device, such as a personal computer 60, the control unit 51 makes a photosensitive drum 10 charged by a charging roller 19 using a charging voltage control unit 52 to a predetermined potential Vopc, for example, 1000V. In addition, the photosensitive drum 10 is rotated to clean a toner remaining thereon using a cleaning blade 22 for a predetermined first time T1. Here, bias voltages Vdev and Vdep are not applied to a developing roller 12 and a deposit roller 16 during the predetermined first time T1. The above cleaning process can be also applied to the photosensitive drum 10 after the developing process is completed.

A surface (portion) of the photosensitive drum 10 is exposed by a laser scanning unit (LSU) 20 for a predetermined second time T2 according to a control of an exposure device control unit 53 to reduce a potential of the exposed portion to a predetermined potential, for example, 100V, thereby forming an electrostatic latent image. The exposure time is the second time T2 to expose the photosensitive drum 10 to the LSU 20 in FIG. 3 and corresponds to the time of forming an image area (IA) on the photosensitive drum 10.

On the other hand, the control unit 51 applies a 900V bias voltage Vdep to the deposit roller 16 using a deposit bias control unit 55, and applies a 600V bias voltage Vdev to the developing roller 12 using a developing bias control unit 54. The deposit roller 16 contacts the developing roller 12 to attach a developer to the developing roller 12. A metering roller 14 controls a height of the developer on the developing roller 12 by pressing the developing roller 12 in a state where a predetermined potential, for example, a 900V voltage, is applied thereto. The developing roller 12 and the deposit roller 16 are applied by the bias voltages Vdev and Vdep for the second time T2 since the exposed portion of the photosensitive drum 10, that is, the IA contacts the developing roller 12.

In addition, the toner is moved from a developing nip region N between the developing roller 12 and the photosensitive drum 10, to the electrostatic latent image area, which has a lower voltage than that of the developing roller 12. Thus, the electrostatic latent image area is developed.

Next, at a non-image area (NIA) where the LSU 20 is turned off or a second surface (portion) of the photosensitive drum 10 is not exposed, the bias voltages applied to the developing roller 12, the deposit roller 16, and the metering roller 14 are turned off. The non-image area NIA corresponds to a third time T3 in FIG. 3. When the deposit roller 16 and the developing roller 12 are turned off simultaneously, a thickness of the developer attached on the developing roller 12 is reduced.

Table 1 shows results of measuring a developer concentration on the developing roller 12 caused by a voltage difference between the developing roller 12 and the deposit roller 16.

TABLE 1

Deposit vector, V

| | 200 | 0 |
|---|---|---|
| Amount of developer, μg/cm² | 62 | 40 |

Referring to table 1, in a case where the deposit vector voltage V (deposit roller voltage Vdep−developing roller voltage Vdev) is 200V, the amount of the developer attached on the developing roller 12 increases about 50% more than that of a case where the vector voltage V is 0V. Therefore, the amount of the developer supplied to the developing nips N at the non-image area NIA is greatly reduced, and the concentration of a liquid carrier that is attached on the photosensitive drum 10 at the developing nip N is also reduced, and consequently, the amount of the liquid carrier attached on the NIA can be reduced greatly. The reduced liquid carrier on the non-image area NIA also reduces a dragging phenomenon on the image area IA.

Operations of a developing process and a cleaning process after the developing process are same as above, and will be omitted.

As described above, the use of the liquid carrier can be reduced according to the developing method of the liquid type electrophotographic image forming device of the present general inventive concept. Also, a dragging problem at the image area caused by an excessive amount of the liquid carrier can be solved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A developing method of a liquid type electrophotographic image forming device, the method comprising:
forming an image area corresponding to an electrostatic latent image formed on a photosensitive drum by scanning light onto a surface of the photosensitive drum that is charged to a predetermined electric potential;
attaching a developer to a surface of a developing roller by applying a first bias voltage to a deposit roller and a second bias voltage to the developing roller;
developing the image area on the photosensitive drum using the developer attached to the developing roller; and
turning off the second and first bias voltages that are applied to the developing roller and the deposit roller, respectively, when a non-image area of the photosensitive drum contacts the developing roller.

2. The method of claim 1, further comprising:
removing a toner of the developer remaining on the photosensitive drum before the forming of the image area,
wherein the removing of the remaining toner comprises applying a predetermined voltage to the photosensitive drum, and not applying the second and first bias voltages to the developing roller and the deposit roller, respectively.

3. The method of claim 1, further comprising:
removing of a toner of the developer remaining on the photosensitive drum after the forming of the image area,
wherein the removing of the remaining toner comprises applying a predetermined voltage to the photosensitive drum and not applying the second and first bias voltages to the developing roller and the deposit roller, respectively.

4. The method of claim 1, wherein the first bias voltage is larger than the second bias voltage.

5. A developing method of a liquid type electrophotographic image forming device, the method comprising:
forming a first image area, a non-image area, and a second image area corresponding to an electrostatic latent image on a photosensitive drum;
charging a developing roller, which supplies a developer to the photosensitive drum, with a potential when the first and second image areas are formed; and
preventing the developing roller from being charged with the potential when the non-image area is formed.

6. The method of claim 5, further comprising:
charging a deposit roller, which supplies the developer to the developing roller, with another potential when the first and second image area are formed; and
preventing the deposit roller from being charged with the another potential when the non-image area is formed.

7. The method of claim 5, wherein the non-image area is disposed between the first and second image areas.

8. The method of claim 5, wherein the forming of the first image area, the non-image area, and the second image area comprises sequentially forming the first image area, the non-image area, and the second image area.

9. The method of claim 5, wherein the forming of the first image area, the non-image area, and the second image area comprises forming the first image area, the non-image area, and the second image area along a surface of the photosensitive drum in a rotation direction,

10. The method of claim 5, further comprising:
developing the electrostatic latent image with the developer supplied from the developing roller according to a preventing operation of the developing roller from being charged with the potential when the non-image area is formed

11. The method of claim 5, wherein the forming of the first image area and the second image area comprises scanning light on the photosensitive drum to form the electrostatic latent image, and the forming of the non-image area comprises preventing the light from being scanned on the photosensitive drum to form the non-image area.

12. The method of claim 11, wherein the preventing of the developing roller from being charged with the potential comprises preventing a voltage source from supplying the potential to the developing roller when the light is prevented to scan the photosensitive drum corresponding to the non-image area.

13. The method of claim 5, further comprising:
charging the photosensitive drum to form the electrostatic latent image,
wherein the forming of the first image area on the photosensitive drum starts a first period of time after the charging of the photosensitive drum.

14. The method of claim 5, further comprising:
charging the photosensitive drum to form the electrostatic latent image,
wherein the charging of the developing roller starts a first period of time after the charging of the photosensitive drum.

15. The method of claim 14, wherein the forming of the first image area comprises forming the first image area for a second period of time,
wherein the charging of the developing roller comprises charging the developing roller for the second period of time.

16. The method of claim 15, wherein the forming of the non-image area comprises forming the non-image area for a third period of time,
wherein the preventing of the developing roller from being charged with the potential comprises preventing the developing roller from being charged with the potential for the third period of time.

17. The method of claim 16, wherein the forming of the second image area comprises forming the first image area for a fourth period of time,
wherein the charging of the developing roller comprises charging the developing roller for the fourth period of time.

18. The method of claim 5, further comprising:
charging the photosensitive drum during forming the first image area, the non-image area, and the second image area; and
preventing the photosensitive drum from being charged a period of time after completing the formation of the first image area, the non-image area, and the second image area,
wherein the preventing of the developing roller from being charged comprises preventing the developing roller from being charged when the formation of the first image area, the non-image area, and the second image area is completed.

19. The method of claim 18, further comprising:
charging the photosensitive drum during forming the first image area, the non-image area, and the second image area; and
preventing the photosensitive drum from being charged a period of time after completing the formation of the first image area, the non-image area, and the second image area,
wherein the preventing of the developing roller from being charged comprises preventing the developing roller from being charged within the period of time after the formation of the first image area, the non-image area, and the second image area is completed.

20. The method of claim 5, wherein the forming of the first image area and the second image area comprises:
scanning light the photosensitive drum to form the first image area and the second image area of the electrostatic latent image; and
charging the photosensitive drum for a period of time longer than that to form the first and the second image areas,
wherein the charging of the developing roller comprises charging the developing roller another period of time shorter than the period of time.

21. The method of claim 5, wherein the forming of the first image area and the second image area comprises:
charging the photosensitive drum for a period of time;
scanning light the photosensitive drum to form the first image area and the second image area of the electrostatic latent image for a second period of time shorter than the period of time; and
charging the developing roller for a third period of time shorter than the period of time.

22. The method of claim 5, wherein the forming of the first image area and the second image area comprises:
charging the photosensitive drum for a period of time;
scanning light the photosensitive drum to form the first image area and the second image area of the electrostatic latent image for a second period of time shorter than the period of time; and
charging the developing roller for a third period of time shorter than the period of time

23. A developing method of a liquid type electrophotographic image forming device, the method comprising:
charging a photosensitive drum for a period of time;
forming a first image area, a non-image area, and a second image area corresponding to an electrostatic latent image on the photosensitive drum for a second period of time shorter than the period of time; and
charging a developing roller, which supplies a developer to the photosensitive drum, with a potential for a third period of time shorter than the period of time.

24. The developing method of claim 23, wherein the charging of the developing roller comprises preventing the developing roller from being charged with the potential when the non-image area is formed.

25. The developing method of claim 23, wherein the charging of the developing roller comprises starting charging the developing roller a predetermined period of time after the charging of the photosensitive drum starts.

26. The developing method of claim 23, wherein the charging of the developing roller comprises terminating charging the developing roller a predetermined period of time before the charging of the photosensitive drum ends.

27. The developing method of claim 23, wherein the forming of the first image area, the non-image area, and the second image area comprises starting forming the first image area, the non-image area, and the second image area a predetermined period of time after charging of the photosensitive drum starts.

28. The developing method of claim 23, wherein the forming of the first image area, the non-image area, and the second image area comprises terminating forming the first image area, the non-image area, and the second image area a predetermined period of time before the charging of the photosensitive drum ends.

29. A developing method of a liquid type electrophotographic image forming device, the method comprising:
forming a first image area, a non-image area, and a second image area corresponding to an electrostatic latent image on a photosensitive drum;
charging a deposit roller and a developing roller, which supply a developer to the photosensitive drum, with a potential and another potential, respectively, when the first and second image areas are formed; and
preventing the deposit roller and the developing roller from being charged with the potential and another potential when the non-image area is formed.
